(19) United States
(12) Patent Application Publication
(10) Pub. No.: US 2019/0205436 A1
(43) Pub. Date: Jul. 4, 2019

(54) System and method for executing database operations on a database

(71) Applicant: Comptel Oy, Helsinki (FI)

(72) Inventor: Tero HEMIÖ, Helsinki (FI)

(73) Assignee: Comptel Oy, Helsinki (FI)

(21) Appl. No.: 15/857,850

(22) Filed: Dec. 29, 2017

(51) Int. Cl. G06F 17/30

(52) U.S. Cl. CPC G06F 17/30289; G06F 17/3056

(57) ABSTRACT

A system (100) for executing database operations on a database (102), the system comprising at least one database (102) and at least one database interface (104) configured to receive an internal database command comprising an internal identifier and in response to said internal database command, initiate execution of a database operation on said database. The system (100) additionally comprises a request interface (106) configured to receive an external database command, the external database command comprising an external identifier, the system (100) also comprising a resolver (108). The request interface (106) is preferably a representational state transfer application programming interface (REST API) and is additionally configured to receive the external database command comprising a unique identifier comprising one or more natural keys, and transmit the external database identifier to the resolver (108), the resolver (108) being configured to translate the external identifier to the internal identifier and transmit the internal identifier to the request interface (106). The request interface (106) is further configured to transmit the received internal database command comprising the internal identifier to the database interface (104) so that the database interface (104) may initiate execution of the database operation.

### TECHNICAL FIELD OF THE INVENTION

The invention is related to information technology in general. More specifically, the invention is related to a system and method for executing database operations on a database.

### BACKGROUND OF THE INVENTION

Data storage systems and data storage management systems are widely used, with relational databases and Structured Query Language (SQL) for database querying and management being prevalent. In the context of modern applications and programming thereof, object-oriented programming has become significant and it may be advantageous to store objects in a database. This may lead to difficulties in management or manipulation of a database comprising objects that are intended to be utilized in relation to object-oriented programming languages. It may be complicated to compose or produce database queries or commands where objects may be identified in a way that is convenient for a user of the database and also for a query language that is utilized to execute the database operations that are specified by commands.

In many database implementations, a unique identifier is assigned to each object in the database, this unique identifier often being a system-generated surrogate key. Surrogate keys have no other value than serving as unique identifiers and add complexity to a system.

### SUMMARY OF THE INVENTION

A purpose of the invention is to alleviate at least some of the problems relating to the known prior art. In accordance with one aspect of the present invention, a system is provided for executing database operations on a database, the system comprising at least one database, at least one database interface configured to receive an internal database command comprising an internal identifier and in response to said internal database command, initiate execution of a database operation on said database. The system additionally comprises a request interface configured to receive an external database command, the external database command comprising an external identifier, the system also comprising a resolver. The request interface is preferably a representational state transfer application programming interface (REST API) and is additionally configured to receive the external database command, wherein the associated external identifier comprises a unique identifier comprising one or more natural keys. The request interface is yet configured to transmit the external database identifier to the resolver, the resolver being configured to translate the external identifier to the internal identifier and transmit the internal identifier to the request interface, receive the internal identifier from the resolver, and transmit the internal database command comprising the internal identifier to the database interface so that the database interface may initiate execution of the database operation.

In another aspect, there is also provided a method according to the independent method claim for executing database operations on a database.

Having regard to the utility of the present invention, according to an embodiment, the present invention may provide a system and method for easily accessing a database via a request interface, preferably a REST API. The request interface may conveniently do so via a database interface that has been constructed to be utilized with the database.

The database interface may be implemented through an object-oriented programming language, which may be advantageous and allow programmers to develop a software-related product that may be easily stored in the database and e.g. used for replication.

Using a REST API request interface, a user of a system may have access to the database without using the programming language of the database interface or a database query language, which may make management and/or manipulation of the database data more straightforward.

Predefined stateless operations may be utilized at the request interface, such as HTTP requests combined with a uniform resource identifier (URI) of a database resource that is to be accessed or manipulated. These operations may be carried out by a user with ease, as they are well known or easily discovered. An output or response may be provided to the user through the request interface that may comprise data e.g. in Extensible Markup Language (XML) or JavaScript Object Notation (JSON) format, the response indicating that an alteration has been to the database or providing data and/data representations originating from the database, possibly also providing hypertext links. The output may thus be conveniently delivered in a form that is readable by a user.

Through a REST API, the request interface may be provided as a web-based service. The database may then be accessed remotely via an Internet connection. Also, the use of a REST API may entail that the architecture of the system is decoupled and simplified so that the database and database interface may be developed separately from the request interface, and the components may evolve independently.

In some embodiments of the invention, there may still be intermediary servers that transmit data between a device hosting the request interface and a device such as a server hosting the database interface. Such a layered system may provide further benefits, such as improving system scalability and security.

Utilizing the invention, a database does not have to be constructed so that e.g. a column should be added solely for the purpose of providing for instance a surrogate key that is only for purposes of identifying an instance or object because identification may be done based on natural keys. This may reduce complexity of a system and eliminate procedures that should be done in order to generate a surrogate key.

Also, the identification of database elements or objects may be done on an intuitive basis through natural keys. A user of the system does not have to be aware of for instance an identification number in order to be able to directly identify an object in the database.

Embodiments of the invention may be used in connection with databases that comprise different types of data. Objects in a database may e.g. be physical resources such as ports comprised in a device, programming resources such as methods, or address resources such as IP addresses.

In an embodiment, an internal identifier is in the form of a string of characters similar to a URI and comprises, in at least a portion thereof, a hierarchy in an opposite order to that which is expressed by an external identifier. Conventionally, URIs may identify a database element, i.e. object or resource so that a hierarchy of classes or objects is expressed starting from the parent and then proceeding to a child. In the internal identifier, it may be possible e.g. to first specify a base level of the database that is to be handled and then proceed by giving a child instance and a parent thereof consequently.

Using the above given way of expressing object identifiers, it may be possible to identify an object using a more concise internal identifier, without having to specify an entire hierarchy or all the parent classes. In these cases, a local internal identifier may be enough to uniquely identify an object. Simpler forms of identifiers may then be used. Internally in the database hierarchy, an instance may be uniquely identified solely e.g. by one attribute value in the context of a parent in the case that a table comprised in the database comprises only children of one parent. A combination of such an attribute value with the unique identifier of the parent may then be a global unique identifier of the child.

An instance persisted in the database table might not be uniquely identifiable based on values of its own attributes only as several similar parent objects might have identical children. When the values of attributes of the child are combined with unique identifier of the parent instance, the combination is unique and thus provides a unique identity for the child.

It may be more natural for a user of a system to identify a database resource or object through defining the hierarchy by first starting at a parent (higher in the hierarchy) and then proceeding to a child and so forth. Through embodiments of the invention, it may be possible for a user of a system to identify an object in this way, with a resolver providing a translation that may be more conveniently used with the database and/or associated software such as the database interface.

Containment hierarchy based identification of the instances is in some use cases more natural than recursive usage of the parent identifier in the combined keys. Through embodiments of this invention the identifier required by the database interface may be easily generated from the containment hierarchy based identifier

When an internal identifier is expressed in such a way that in at least part of the internal identifier, a hierarchy is disclosed so that a child is given prior to a parent, the internal identifier may be more conveniently utilized with the database and/or database interface, as it may not be necessary to go through an entire hierarchy in order to identify an object.

Also, this type of representation is similar to that which may be utilized in standard query languages, such as SQL. A database interface may be able to convert the internal database command (comprising the internal identifier) into SQL form and then execute or perform the database operation through an SQL request. The database interface may in some embodiments comprise or be able to communicate with an SQL interface which may perform the database operation.

Through embodiments of the invention, a system and method may be provided for translating identifiers from ones that may be easily understood by users to ones that may be easily utilized in database commands and vice versa.

Although the present invention is primarily intended for use with relational databases, it may also be useful in some situations also with object databases. A database interface may be associated with one or more databases. A request interface may be able to be associated with one or more database interfaces.

The exemplary embodiments presented in this text are not to be interpreted to pose limitations to the applicability of the appended claims. The verb “to comprise” is used in this text as an open limitation that does not exclude the existence of unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

The previously presented considerations concerning the various embodiments of the arrangement may be flexibly applied to the embodiments of the method mutatis mutandis, and vice versa, as being appreciated by a skilled person.

### BRIEF DESCRIPTION OF THE DRAWINGS

Next the invention will be described in greater detail with reference to exemplary embodiments in accordance with the accompanying drawings, in which:

FIG. 1 illustrates an exemplary system according to one embodiment of the invention,

FIG. 2 shows a diagram that may aid in demonstrating some of the features of embodiments of the invention,

FIG. 3 gives an exemplary of a UML diagram that may be utilized in an embodiment of the invention and shows an example of how the UML diagram may be utilized to derive an external identifier,

FIG. 4 gives another example of a UML diagram and corresponding exemplary internal and external identifiers,

FIG. 5 shows a further UML diagram and corresponding exemplary internal and external identifiers,

FIG. 6 shows one more UML diagram and corresponding exemplary internal and external identifiers,

FIG. 7 illustrates an exemplary table structure hierarchy that may aid in demonstrating how external and/or internal identifiers may be derived in an embodiment of the invention,

FIG. 8 shows steps that may be performed in a method according to an embodiment of the invention, and

FIG. 9 shows a sequence diagram according to an exemplary embodiment of a method and use scenario that may be implemented through one embodiment of the invention.

### DETAILED DESCRIPTION

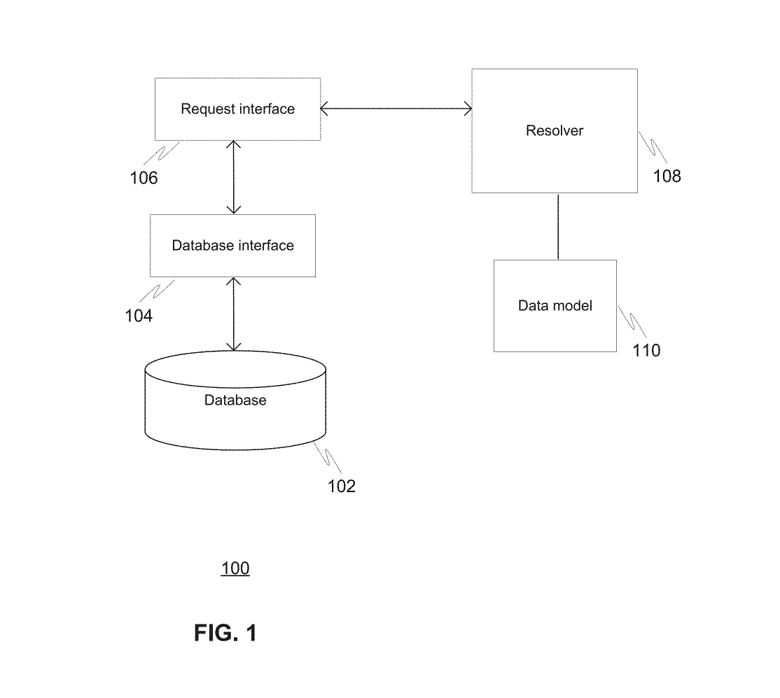

FIG. 1 gives an exemplary system 100 according to an embodiment of the invention. The system 100 comprises at least one database 102, which may be a relational database, the database 102 being configured to act as a data storage. The database 102 may be utilized in connection with an object-oriented programming language such as for instance Java, C++, C#, Python, PHP, Ruby, or Perl, and be used for storing objects. The system 100 also comprises a database interface 104 that is configured to have access to the database 102 in order to manage the data stored in the database 102. The database interface 104 may preferably be an application programming interface (API) that may be implemented with an object-oriented programming language.

The database interface 104 is configured to receive a database command and in response to said database command, perform or at least initiate execution of a database operation on the data comprised in the database 102. A database operation may be related to managing or manipulating data that is stored in the database 102.

The system 100 also comprises a request interface 106, the request interface being configured to receive a database command and transmit the database command to the database interface 104 so that the database interface 104 may initiate the database operation. It should be noted that here the database command that is received by the request interface 106 may not be directly utilized by the database interface 104, and the database command that is transmitted to the database interface 104 has been transformed from the database command that has been received by the request interface, which will be described below.

The request interface is preferably a REST API and the database command received by the request interface is preferably in the form of an HTTP request, and comprises a request such as PUT, POST, GET, or DELETE. The REST API may be for instance web-accessible and provide convenient access to the database 102 and the ability to use HTTP requests may give a non-complicated way to manage the database data.

The REST API may comprise a user interface for allowing a user of the system 100 to provide the external database command. The user interface may also be utilized for providing an output to the user of the system 100.

The database command received by the request interface 106 is referred to here as an external database command and comprises an external identifier. The external identifier may comprise a unique identifier that may be used to uniquely identify an object that is comprised in the database 102. The external identifier may be in the form of a URI and indicate an object that is comprised in the database 102, wherein the database operation that is to be performed in response to the database command shall involve the object that is indicated by the external identifier. For instance, an external database command may comprise at least the request PUT and a URI and an entity, possibly object, that is to be stored.

The URI may comprise one or more natural keys. Natural key may here refer to an attribute of the object that the URI may refer to, with the combination of the natural keys being a unique identifier of that object. The URI may be a relative URI or it may be an absolute URI.

The request interface 106 is additionally configured to transmit the received external identifier to a resolver 108, which will translate the external identifier to an internal identifier and transmit the internal identifier to the request interface 106. The translation of the identifier may be carried out by the resolver 108 by utilizing a data model 110 that the resolver 108 has access to.

The request interface 106 will, after receiving the internal identifier, transmit a database command to the database interface 104, the transmitted database command being referred to here as an internal database command, the internal database command comprising the internal identifier.

In an embodiment, the transmitted internal database command may comprise a request that has been translated from HTTP form to another form, such as for example a form that is suitable with an object-oriented programming language that may have been used to implement the database interface 104.

The internal identifier will, also as in the case of the external identifier, indicate the object in the database 102 that should be involved in the database operation that is requested by the database command (internal and external). The internal identifier is translated from the external identifier such as a URI to a form that may be conveniently utilized by the database interface 104.

In response to the internal database command, the database interface 104 may perform or execute or cause execution of a database operation originally specified by the external database command on the database 102. For example, if an external database command is in the form of PUT URI {entity}, the database operation will result in an enclosed entity to be stored under the specified URI.

In an embodiment, the database interface 104 may convert or translate the internal database command to an SQL command or request, and in response to the SQL command, the database operation may then be performed.

In one other embodiment, the database interface 104 may comprise or have access to an SQL interface, which may convert the internal database command into an SQL command which may then be utilized in order to perform the database operation.

After the database operation has been performed, information relating to the database operation (a database command result) may be transmitted from the database interface 104 to the request interface 106. For example, an object or data at least relating to an object may be retrieved from the database 102. An internal identifier may additionally or alternatively be transmitted to the request interface 106 from the database interface 104. In this case, the request interface 106 may transmit the received internal identifier to the resolver 108 to be translated into an external identifier.

The external identifier that may be received from the resolver 108 may be provided to a user of the system 100 through a user interface of the request interface 106 as an output. Additionally or alternatively, an output may comprise other data that is related to the performed database operation. The output may be or may comprise data that is in Extensible Markup Language (XML) or JavaScript Object Notation (JSON) form, for instance.

The output may provide to a user of the system 100 a confirmation message that may comprise an external identifier or in some other way indicate that a database operation according to that which has been requested by the external database command has been performed.

In some use cases an output may comprise an object or database resource and/or a representation of an object or database resource that is requested by the external database command.

The system 100 depicted in FIG. 1 is a functional entity that may be realized in various ways. At least some of the components of the system 100, e.g. the database 102 and the database interface 104, may be implemented on the same physical device, such as a server. In other cases, any of the components may be distributed over various physical devices. In some use cases, at least the database interface 104 may be accessed remotely via the request interface 106. Some components of the system 100 may be realized as subroutines that are operated within the same software.

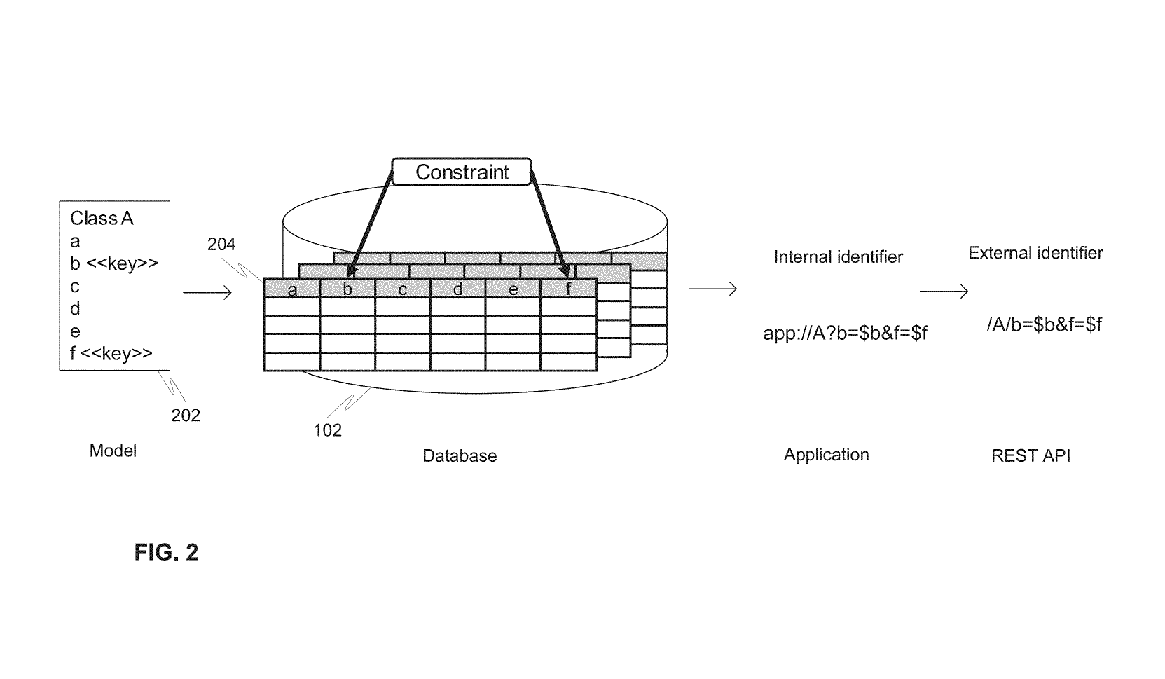

FIG. 2 shows a diagram that may aid in demonstrating some of the features of embodiments of the invention. In an embodiment, a data model 110 may be constructed. An exemplary partial data model 202 is given in FIG. 2. The partial data model 202 defines a class A with attributes a-f. It may be established that only one attribute will not uniquely identify an instance of the class A in this case but that the attributes b and f will together suffice. In FIG. 2, the table 204 illustrates the class A and the rows may denote the instances of the class, with the columns representing the attributes associated with the instances. A database may comprise a plurality of classes, as is easily understood by the skilled person.

The database 102 may be composed as is formulated by the data model 202 (or 110). In some embodiments, data model 110, 202, may be constructed on the basis of a database 102. The data model 110, 202, may be constructed as a UML model, which may be implemented in the database 102.

A constraint may be implemented in the database 102 in order to constitute the unique identifiers that may be used to uniquely identify an instance or in other words an object, of the database 102. As with the example above, where attributes a and f uniquely define an instance of the class A, the attributes a and f are now natural keys that may be used in order to uniquely identify an instance. In the context of the database 102 and the database interface 104, the internal identifier may now be defined or constructed and may for example be in the form app://A?b=$b&f=$f, where $b and $f may specify values for the attributes b and f and may, depending on the attribute, be e.g. numbers or strings, app here identifying the application or database interface.

From the data model 110, 202, an external identifier such as a URI may be derived. In the example of FIG. 2., the URI may be in the form of a /A/b=$b&f=$f, where once more $b and $f may specify values for the attributes b and f. The resolver 108 may have access to a data model 110, 202 or a resolver 108 may have been implemented using data that is comprised in a data model 110, 202.

A resolver 108 may, based on the data model 110, 202, translate an external identifier to an internal identifier or it may additionally or alternatively translate an internal identifier to an external identifier.

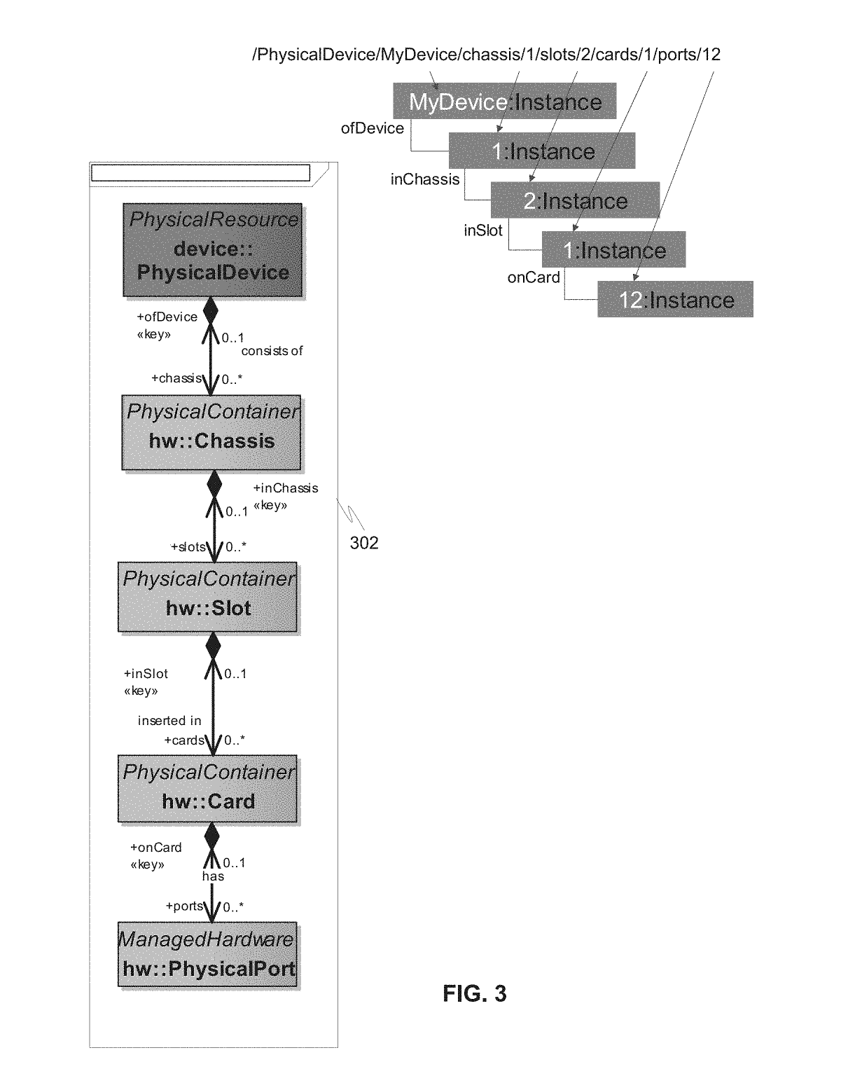

FIG. 3 gives an exemplary UML diagram 302 that may in an embodiment of the invention be utilized to construct a data model 110, 202. The UML diagram 302 also demonstrates the hierarchical structure that may be present in a data model 110, 202 and the objects of the corresponding database 102. The UML diagram 302 shows the classes PhysicalDevice, Chassis, Slot, Card, and Physical Port and their composition relationships, such as that a PhysicalDevice may have 0 to any number of chassis and a chassis may have 0 or 1 Physical Devices.

Above the UML diagram 302 in FIG. 3, it is shown how a UML model and the the UML diagram 302 may be used to derive an external identifier. The external identifier here in this example may be /Physical Device/MyDevice/chassis/1/slots/2/cards/1/ports/12. The string MyDevice is an attribute that may be used to define an instance of the class Physical Device, while the number 1 after chassis is an attribute that may be used to define an instance of the class Chassis and so on, as may easily be understood from FIG. 3.

The resolver 108 may then from the external identifier such as that disclosed above, translate the external identifier to an internal identifier which may be app://com.db.x.PhysicalPort?portNumber=12&amp;onCard.name=1&amp;onCard.inSlotslotReference=2&amp;onCard.inSlotinChassis.name=1&amp;onCardinSlot.inChassis.ofDevice.name=MyDevice, to show an example of a form that the internal identifier may be expressed in. In the exemplary internal identifier, db.x may identify the base level of the database 102 that is referred to.

As may be seen from the exemplary internal and external identifiers above, an external identifier such as a URI may be constructed by beginning from the highest level of the database hierarchy and progressing to the second highest level and so on, continuing in the hierarchy from “top down”. An internal identifier, on the other hand, may, after possibly specifying the base level in order to specify the appropriate database 102, be constructed by beginning from the lowest item in the hierarchy and then proceeding to the second lowest etc.

In some cases, an internal identifier may be given as a local internal identifier without having to specify the entire hierarchy. For instance, using the above exemplary URI, in the context of card 1, it may be possible to identify the object that is referred to by the URI by giving a local internal identifier that may be truncated for instance to portNumber=12. Thus, it may be possible to use truncated or local internal identifiers in a local context, e.g. if a database operation is requested from a certain location that is at an intermediate level of the hierarchy which is expressed by a URI.

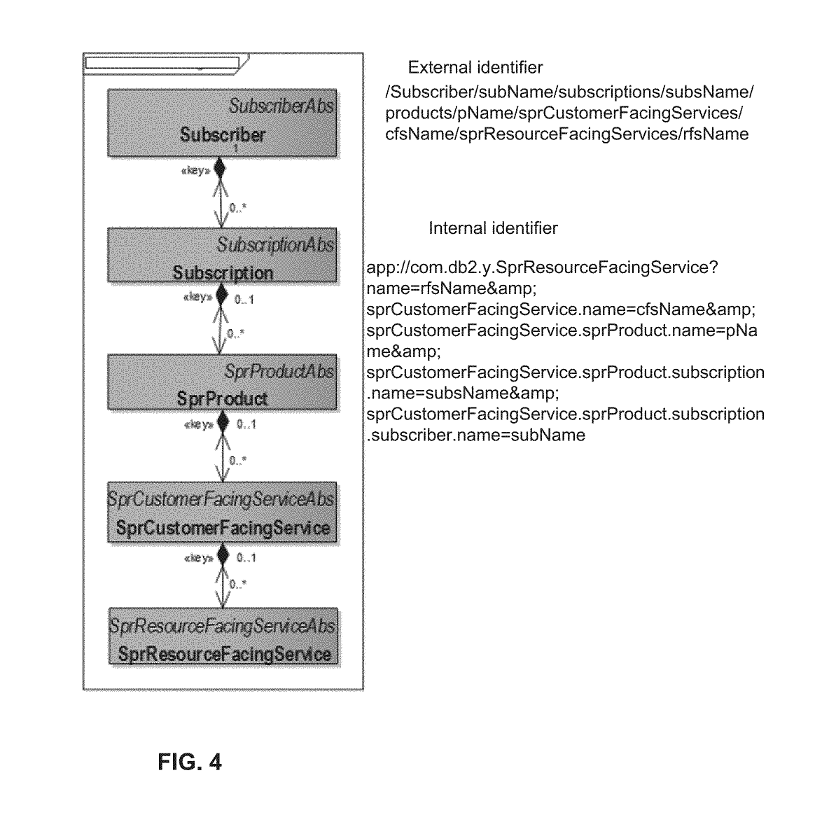

FIG. 4 gives another example of a UML diagram and corresponding exemplary internal and external identifiers. In this case the database resource that is referred to by the identifiers is related to resource facing services that may be comprised in a database 102, where the database 102 may for instance be a subscriber profile repository (SPR). The external identifier /Subscriber/subName/subscriptions/subsName/products/pName/sprCustomerFacingServices/cfsName/sprResourceFacingServices/rfsName may then be an example of an external identifier that may be translated by a resolver 108 into an internal identifier such as app://com.db2.y.SprResourceFacingService?name=rfsName&amp;sprCustomerFacingService.name=cfsName&amp;sprCustomerFacingService.sprProduct.name=pName&amp;sprCustomerFacingService.sprProductsubscription.name=subsName&amp;sprCustomerFacingService.sprProductsubscription.subscriber.name=subName.

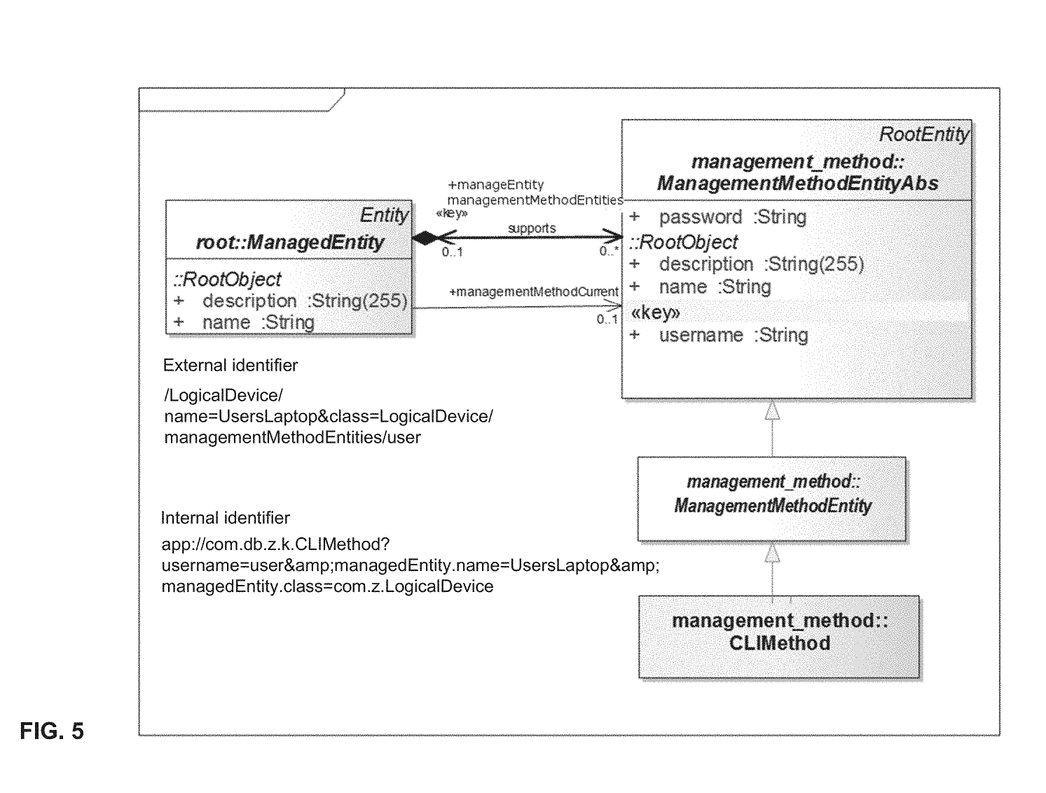

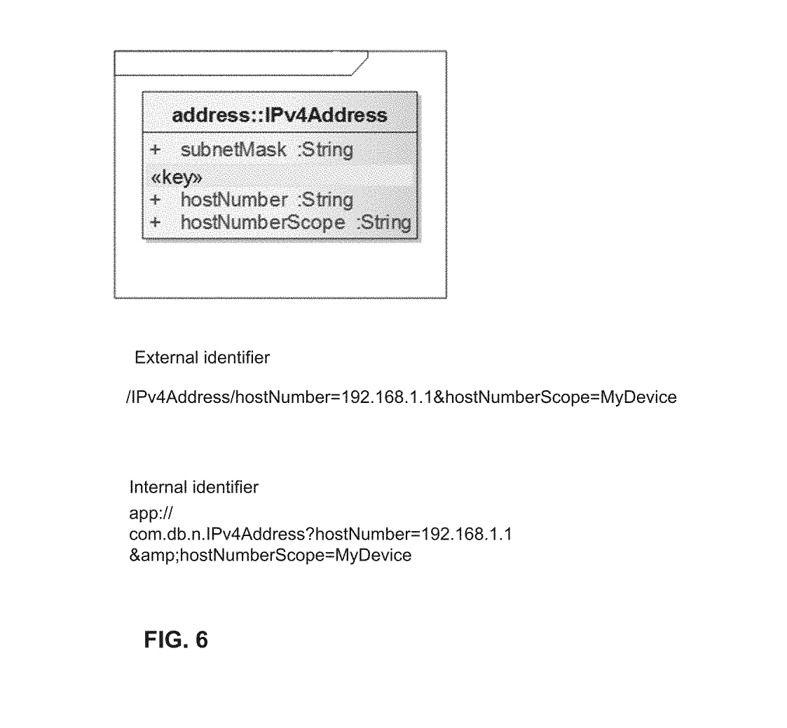

FIGS. 5 and 6 give further examples of UML diagrams and corresponding exemplary external and internal identifiers. In FIG. 5, the database resources that are referred to are related to programming resources and in FIG. 6 the resource is an address resource, here an IPv4 address.

Through embodiments of the invention, many different types of database resources may therefore be dealt with. Resources may be e.g. physical resources, programming resources, or address resources. Abstract classes may also be handled. A database 102 may in some case be for instance a combined services and resources inventory or establish a portion thereof. The database 102 may establish at least a portion of a federated database.

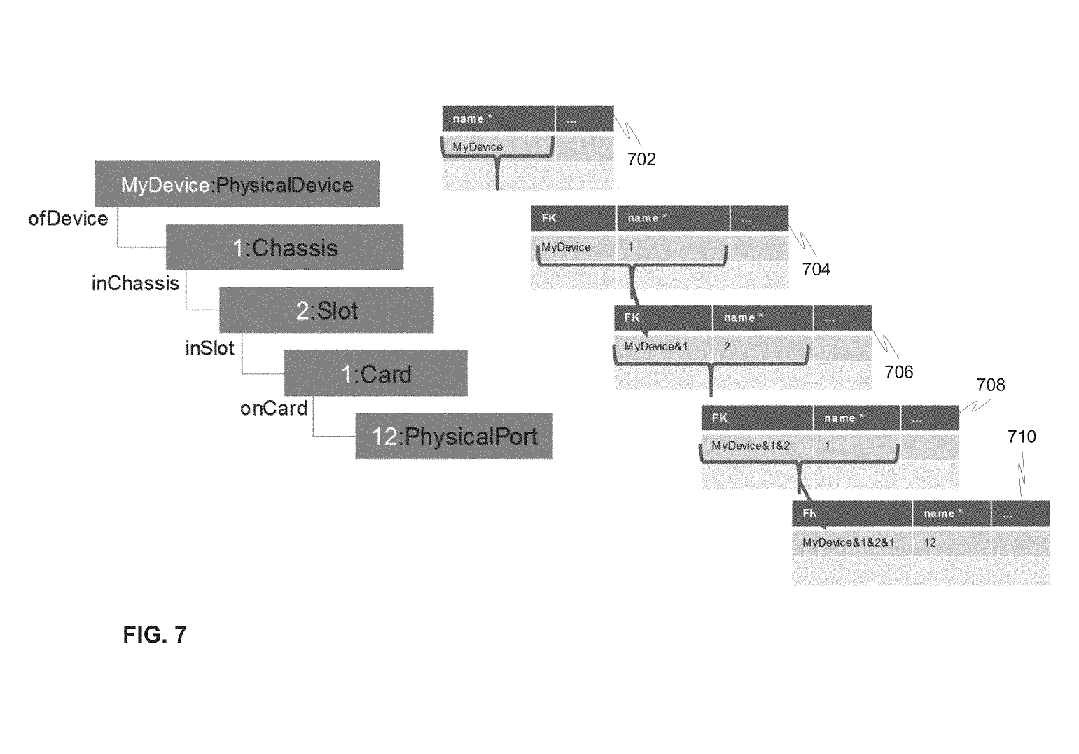

FIG. 7 illustrates an exemplary table structure hierarchy that may aid in demonstrating how external and/or internal identifiers may be derived in an embodiment of the invention. The example given in FIG. 3 is utilized here, i.e., in relation to an object (a physical port here) that is identified by the URI /Physical Device/MyDevice/chassis/1/slots/2/cards/1/ports/12.

In the class hierarchy, at the highest level is the class PhysicalDevice, the instances of which may be given in a database 102 in the table 702. The parent instance in this case is the object which is specified in the top column named MyDevice, the children of which that are instances of the class Chassis are given in table 704. Here, all instances (or rows) in table 704 are children of MyDevice, MyDevice here being a foreign key (FK) that may be used in table 704 and being a unique identifier of the instance MyDevice. In the context of table 704, “1” is a unique local identifier for the instance that is represented by the first row of table 704, which indicates that what is referred to is Chassis 1 on MyDevice (/PhysicalDevice/MyDevice/chassis/1). Thus, the FK coming from the parent in combination with a natural key (an attribute value, here 1) may constitute a globally unique identifier for a child instance.

Next in the hierarchy of the object in question is an instance of class Slot that is a child of the above identified/PhysicalDevice/MyDevice/chassis/1, which is given in table 706. The FK is once again obtained through the parent, while “2” may be a unique identifier in the context of table 706. Tables 708 and 710 may be understood accordingly, and a skilled person may thus comprehend that the URI of/Physical Device/MyDevice/chassis/1/slots/2/cards/1/ports/12 may be constructed.

For a user of the system 100, constructing such an external identifier beginning from the highest level of hierarchy may be an easy and intuitive way of identifying an object. For a database 102, database interface 104 and/or a query language, however, an identifier that is constructed beginning from the lowest level or child may be more convenient.

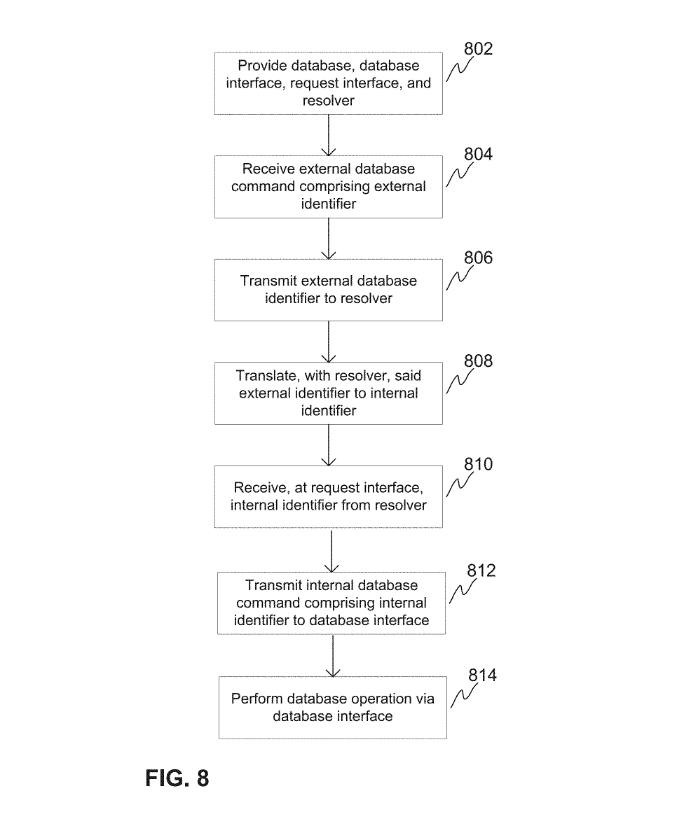

FIG. 8 illustrates steps that may be performed in a method according to an embodiment of the invention. At 802, a database 102, database interface 104, request interface 106, and resolver 108 are provided. The request interface 106 receives an external database command comprising an external identifier at 804, and transmits at least the external identifier to the resolver 108 at 806.

At step 808, the resolver translates the external identifier to an internal identifier. At least the internal identifier is then received at the request database 104 at 810, while an internal database command comprising the internal identifier is transmitted from the request database 106 to the database interface 104 at 812. Finally, at 814, the database interface 104 may perform or execute or actuate or initiate performing or execution of a database operation involving the data or objects in a database 102, the database operation being performed based on the received internal database command.

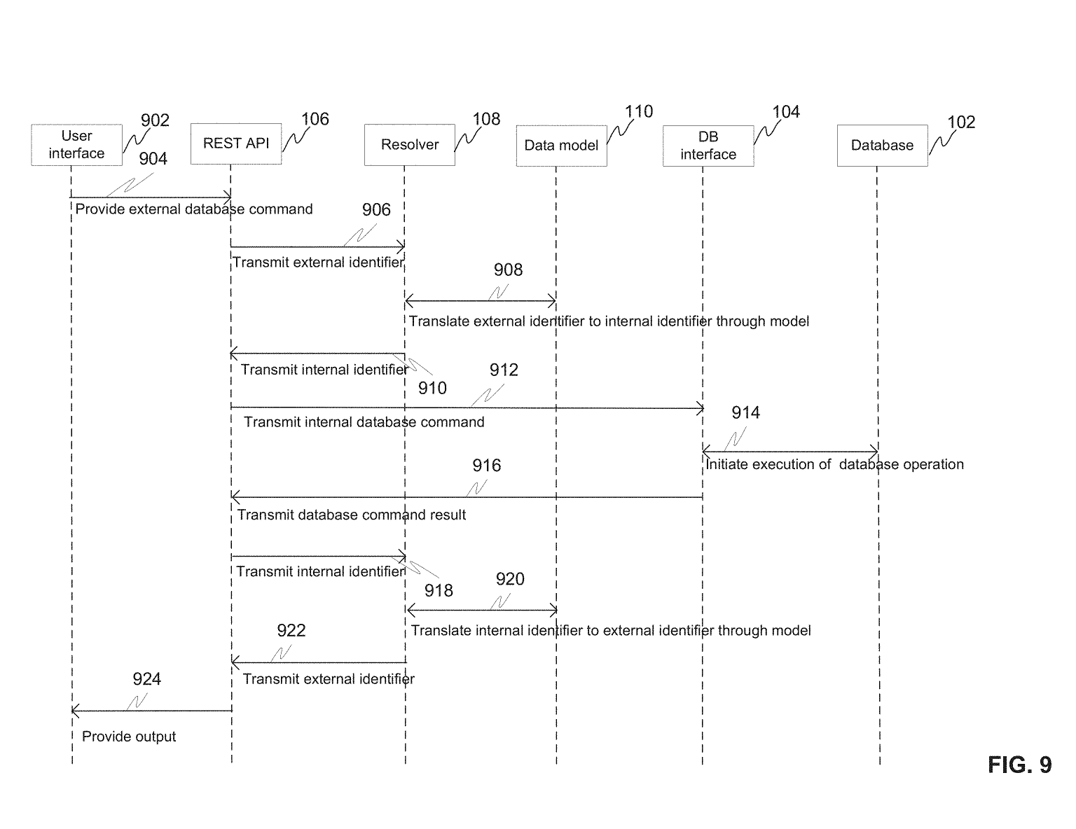

FIG. 9 shows a sequence diagram of a method and use scenario that may be implemented through an embodiment of the invention. Through a user interface 902 of a REST API 106, a user of a system 100 may provide at 904 an external database command that may comprise an HTTP request comprising an external identifier such as a URI. The external database command may e.g. be in the form of GET/A/b=$b&f=$f with A being a class of objects and the attributes b and f defining a constraint and together uniquely identifying an instance of the class A that has attribute values that are specified with the values at $b and $f.

After receiving the external database command, the REST API 106 may transmit at least the external identifier to a resolver 108 at 906. The resolver 108 may translate, at 908, the external identifier to an internal identifier through utilizing a data model 110. The internal identifier may be in the form of app://A?b=$b&f=$f, where the form of the internal identifier is globally unique at least at a specific point of hierarchy in a database 102 and may be utilized by a database interface 104. At 910, the internal identifier may be transmitted from the resolver 108 to the REST API 106.

At 912, an internal database command comprising the internal identifier may be transmitted from the REST API 106 to the database interface 104. The internal database command may comprise a database request that has been translated from HTTP form to some other form, such as into a programming language that has been used to implement the database interface 104.

At 914, the database interface 104 may, in response to the received internal database command, initiate execution of a database operation on the object data comprised in the database 102. At 914, objects or other data may be retrieved from the database 102 or received therefrom in response to the performed database operation.

Data that is retrieved from the database 102 as a result of the performed database operation may depend on the request and also on the resource that is referred to by a URI. For example, in connection with a GET request, information that is identified by the request URI is retrieved. If, for instance, the request URI refers to a data-producing process, the data produced by the process is the information, possibly an entity, that is retrieved.

After the database operation has been performed, a database command result may be transmitted at 916 to the REST API 106 from the database interface 104. The database command result may comprise an internal identifier that the REST API may transmit to the resolver 108 at 918 for the resolver 108 to translate to an external identifier. The resolver 108 may translate the internal identifier to an external identifier at 920, while at 922, the external identifier is transmitted to the REST API 106.

An output may be provided at 924 to a user of the system 100 through the user interface 902. The output may comprise the external identifier that that may have been received by the REST API 106 at 922. In some cases the output may provide a confirmation that a certain database operation has been performed. An output may additionally or alternatively comprise other data or one or more entities that may have been retrieved from the database 102 in response to the performed database operation.

The invention has been explained above with reference to the aforementioned embodiments, and several advantages of the invention have been demonstrated. It is clear that the invention is not only restricted to these embodiments, but comprises all possible embodiments within the spirit and scope of inventive thought and the following patent claims.

The features recited in dependent claims are mutually freely combinable unless otherwise explicitly stated.

1. A system for executing database operations on a database, the system comprising
at least one database,
at least one database interface configured to receive an internal database command comprising an internal identifier and in response to said internal database command, initiate execution of a database operation on said database,
a request interface configured to receive an external database command, the external database command comprising an external identifier, and
a resolver,
wherein the request interface is preferably a representational state transfer application programming interface (REST API) and is additionally configured to
receive the external database command, wherein the associated external identifier comprises a unique identifier comprising one or more natural keys,
transmit the external database identifier to the resolver, the resolver being configured to translate the external identifier to the internal identifier and transmit the internal identifier to the request interface,
receive the internal identifier from the resolver, and
transmit the internal database command comprising the internal identifier to the database interface so that the database interface may initiate execution of the database operation.

2. The system of claim 1, wherein the request interface is additionally configured to
receive a database command result from the database interface, the database command result comprising an internal identifier,
transmit the internal identifier to the resolver, the resolver being additionally configured to translate the internal identifier into an external identifier,
receive the external database identifier from the resolver.

3. The system of claim 1, wherein the request interface is additionally configured to provide an output that is indicative of a performed database operation to be available to a user of the system.

4. The system of claim 3, wherein the output comprises data that is in a format selected from the group of Extensible Markup Language (XML) and JavaScript Object Notation (JSON).

5. The system of claim 1, wherein the external database identifier is in the form of a unique resource identifier (URI).

6. The system of claim 1, wherein the external database command is in the form of an HTTP request.

7. The system of claim 1, wherein the resolver is configured to perform the translation of the identifiers based on a data model.

8. The system of claim 7, wherein the data model is a UML model.

9. The system of claim 1, wherein the internal identifier is in the form of a string of characters and wherein a hierarchy expressed by the external identifier is expressed in at least a portion of the internal identifier in an opposite order.

10. The system of claim 1, wherein the database is a relational database, optionally accessible via an SQL API.

11. The system of claim 1, wherein in order to initiate the execution of the database operation, the database interface is configured to convert the internal database command into an SQL command and/or communicate with an SQL interface.

12. The system of claim 1, wherein the database comprises a hierarchical structure wherein the database comprises at least one table where rows represent instances of the same class which are all related to the same parent.

13. A method for executing database operations on a database, the method comprising at least
providing at least one database, a database interface, a request interface, and a resolver,
receiving, by the request interface, an external database command comprising an external identifier,
receiving, by the database interface, an internal database command comprising an internal identifier, said internal database command originating from the request interface,
initiating, by the database interface, in response to the internal database command, execution of a database operation on the database,
wherein the internal database command is obtained through the request interface additionally executing steps of
transmitting the external identifier to a resolver,
receiving, from the resolver the internal identifier, which has been obtained by the resolver translating the external identifier to the internal identifier,
transmitting the internal database command to the database interface.

14. The method of claim 13, the method additionally comprising the request interface performing at least the steps of
receiving a database command result from the database interface, the database command result comprising an internal identifier,
transmitting the internal identifier to the resolver, the resolver translating the internal identifier into an external identifier,
receiving the external database identifier from the resolver.

15. The method of claim 13, the method additionally comprising providing an output and making the output available to a user.
